(19) United States
(12) Patent Application Publication
(10) Pub. No.: US 2006/0239760 A1
(43) Pub. Date: Oct. 26, 2006

(54) Grout sealer applicator device

(76) Inventor: Lung-Chih Chen, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/053,040

(22) Filed: Feb. 8, 2005

(51) Int. Cl. B43M 11/02

(52) U.S. Cl. 401/219

(57) ABSTRACT

A grout sealer applicator device includes a container having a chamber to receive grout sealer material, a control ferrule attached onto a mouth of the container and having an outlet port for discharging the sealer material. A valve member is attached onto the mouth of the container, and includes a nozzle having a discharge aperture for selectively discharging the sealer material. A discharge wheel is rotatably attached to the control ferrule, and includes an outer peripheral surface facing toward the outlet orifice of the outlet port of the control ferrule, for receiving the grout sealer material from the outlet port, and thus for allowing the grout sealer material to be easily applied onto ground with the discharge wheel.

### BACKGROUND OF THE INVENTION

1. Field of the Invention

The present invention relates to a grout sealer applicator device, and more particularly to a grout sealer applicator device having a sealer receiving and storing structure and an easily applying structure.

2. Description of the Prior Art

Typical grout sealer applicator devices have been developed and provided for applying a liquid grout sealer onto ground or the like, and comprise an elongated tubular body defining a sealer reservoir, a sealer valve at an end of the tubular body, and a spring member biasing the sealer valve into a closed position and pressure activated by axial pressure on the tubular body into an open position against the bias of the spring member, and an applicator wheel carried by the sealer valve for receiving sealer from the reservoir through the sealer valve in the open position and for distributing sealer.

For example, U.S. Pat. No. 6,386,782 to White, Sr. discloses one of the typical grout sealer applicator devices comprising a spring member disposed between a sealer valve and an elongated tubular body. For applying the grout sealer, the tubular body is required to be depressed onto the sealer valve against the spring member, into an open position.

However, it will be difficult to control the pressing of the tubular body onto the sealer valve against the bias of the spring member, particularly when moving the applicator wheel along the ground. For example, when a pressing force is applied onto the tubular body and thus onto the sealer valve against the bias of the spring member, the pressing force may further force the applicator wheel to move forwardly relative to the ground, such that the users may not easily control and apply the pressing force onto the tubular body and the applicator wheel, and such that the sealer may not be easily controlled to flow from the reservoir through the sealer valve and the applicator wheel for distributing sealer.

The present invention has arisen to mitigate and/or obviate the afore-described disadvantages of the conventional grout sealer applicator devices.

### SUMMARY OF THE INVENTION

The primary objective of the present invention is to provide a grout sealer applicator device including a sealer receiving and storing structure for allowing the sealer to be easily applied onto ground or the like.

In accordance with one aspect of the invention, there is provided a grout sealer applicator device comprising a container including a chamber formed therein to define a sealer reservoir and to receive grout sealer material therein, the container including a mouth provided on top thereof, a control ferrule attached onto the mouth of the container, and including an outlet port having an outlet orifice formed therein, for discharging the sealer material, a valve member attached onto the mouth of the container, and including a nozzle communicating with the chamber of the container, the nozzle including a discharge aperture formed therein, for selectively discharging the sealer material, and a discharge wheel rotatably attached to the control ferrule, and including an outer peripheral surface facing toward the outlet orifice of the outlet port of the control ferrule, for receiving the grout sealer material from the outlet orifice of the outlet port, and thus for allowing the grout sealer material to be easily applied onto ground with the discharge wheel.

The valve member includes a panel having an outer peripheral flange engaged onto the mouth of the container, and the control ferrule is engaged onto the outer peripheral flange of the panel, to stably compress and retain the panel of the valve member on top of the mouth of the container. The nozzle of the valve member is arrangeable and extendible into the chamber of the container, to selectively enclose the chamber of the container, and to prevent the grout sealer material from flowing out of the container.

The control ferrule includes a casing provided thereon, and having the outlet port extended from the casing, and includes a tube extended into the casing, for engaging with the nozzle of the valve member. The nozzle includes a root portion, the tube of the casing is engaged with the root portion of the nozzle, to allow the discharge aperture of the nozzle to be easily opened. The control ferrule includes at least one arm extended from the casing, the discharge wheel is rotatably attached to the arm of the control ferrule with a wheel axle.

A cover may further be provided and selectively attachable onto the mouth of the container when the control ferrule is disengaged from the mouth of the container. The cover includes an outlet port extended therefrom, and an outlet valve element engaged into the outlet port of the cover, for selectively discharging the sealer material.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a grout sealer applicator device in accordance with the present invention;

FIG. 2 is an exploded view of the grout sealer applicator device;

FIG. 3 is a partial cross sectional view of the grout sealer applicator device, taken along lines 3-3 of FIG. 1;

FIG. 4 is a partial cross sectional view similar to FIG. 3, illustrating the operation of the grout sealer applicator device;

FIG. 5 is another partial cross sectional view illustrating the operation of the grout sealer applicator device which is disposed up-side-down;

FIG. 6 is an enlarged partial perspective view of the grout sealer applicator device;

FIG. 7 is a perspective view illustrating the other arrangement of the grout sealer applicator device;

FIG. 8 is a partial cross sectional view of the grout sealer applicator device, taken along lines 8-8 of FIG. 7; and

FIG. 9 is a partial cross sectional view similar to FIG. 8, illustrating the operation of the grout sealer applicator device as shown in FIGS. 7 and 8.

### DETAILED DESCRIPTION OF THE PREFERRED EMBODIMENT

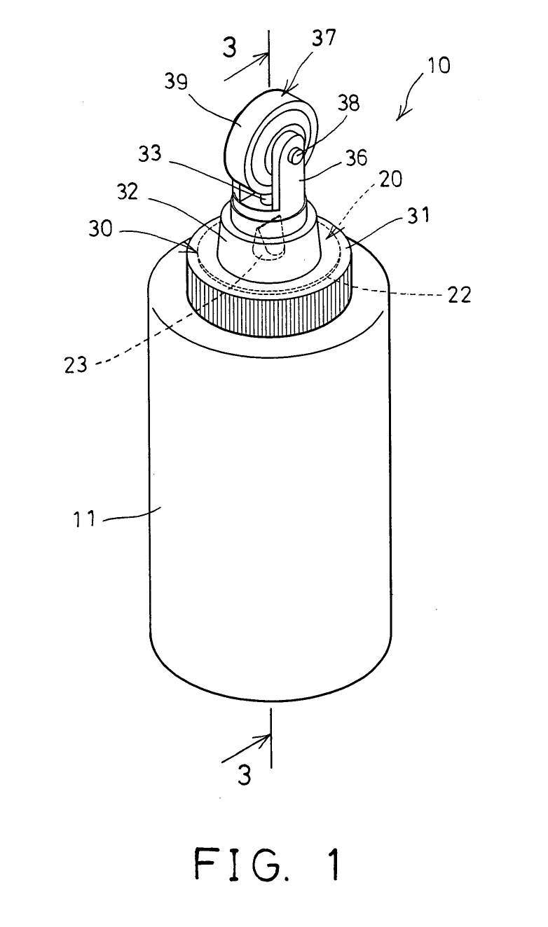

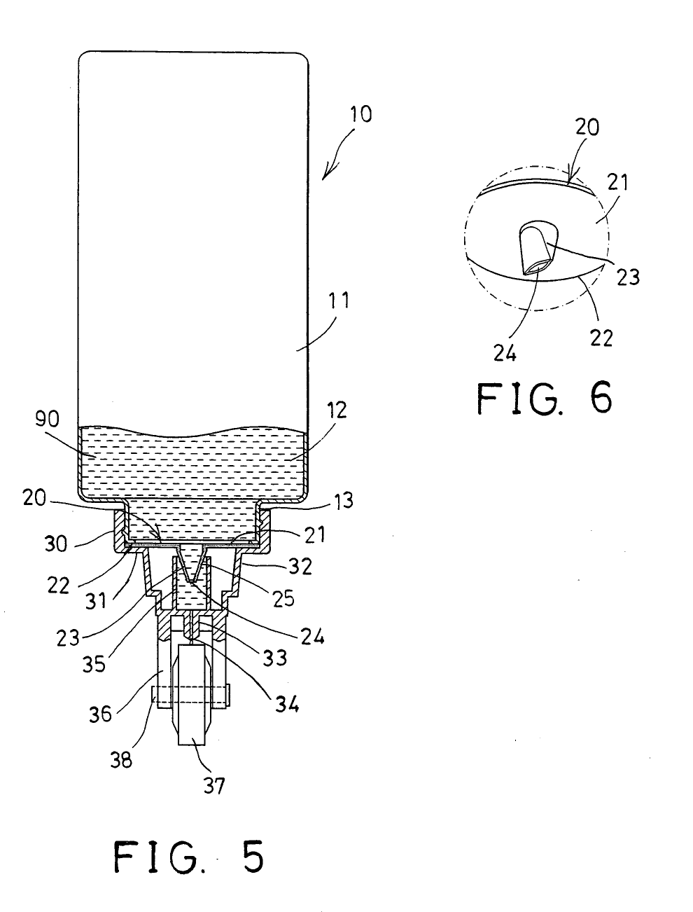

Referring to the drawings, and initially to FIGS. 1-3, a grout sealer applicator device 10 in accordance with the present invention comprises a container 11 including a chamber 12 provided or formed therein to define a sealer reservoir and to receive grout sealer material 90 therein (FIG. 5). The container 11 includes a mouth 13 provided or formed on top thereof, and having an upper peripheral surface 14 formed thereon.

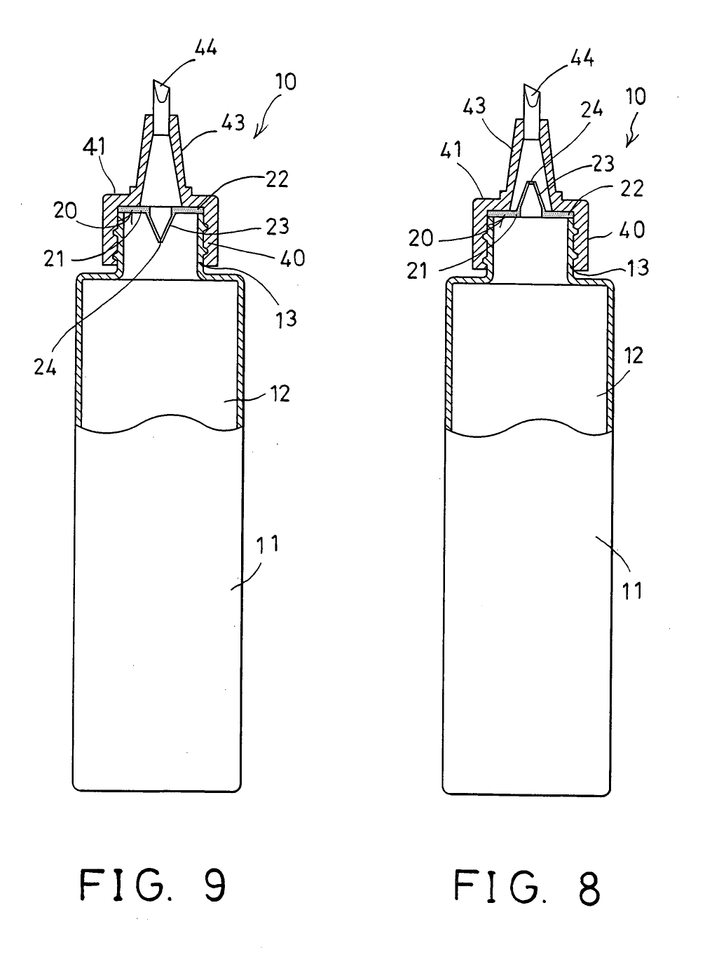

A valve member 20 includes a panel 21 engageable onto the mouth 13 of the container 11, and having an outer peripheral flange 22 for engaging and seating onto the upper peripheral surface 14 of the mouth 13 of the container 11, and includes a nozzle 23 extended from the panel 21 and engageable into and communicating with the chamber 12 of the container 11 (FIGS. 4, 9), or extendible out of the container 11 (FIGS. 1, 3, 5 and 7-8).

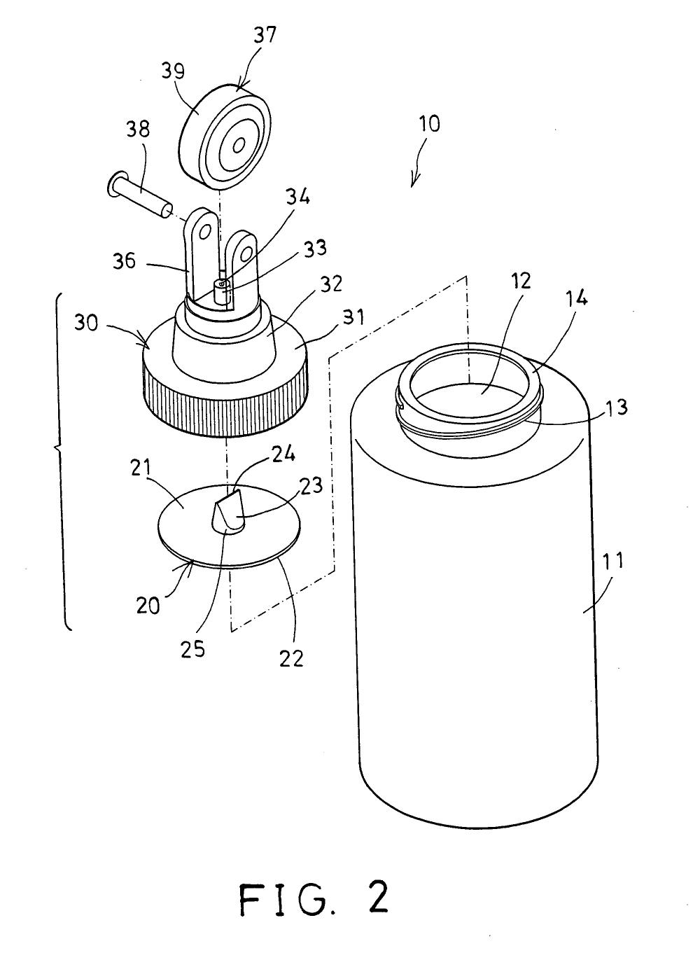

The nozzle 23 of the valve member 20 includes a discharge aperture 24 formed therein (FIGS. 2-6), for discharging the sealer material. The panel 21 and/or the nozzle 23 of the valve member 20, and particularly the nozzle 23 of the valve member 20 is preferably made of flexible or, squeezable rubber or plastic or synthetic or metal materials, to allow the nozzle 23 to be squeezed or deformed, and thus to allow the discharge aperture 24 of the nozzle 23 of the valve member 20 to be opened (FIG. 6).

A control ferrule 30 is engageable or threadable with the mouth 13 of the container 11, for attaching or securing onto the mouth 13 of the container 11, and includes a peripheral wall 31 for engaging onto the outer peripheral flange 22 of the panel 21, and thus for stably compressing and retaining the panel 21 of the valve member 20 on top of the mouth 13 of the container 11, and thus for stably retaining and positioning the nozzle 23 of the valve member 20 relative to the container 11.

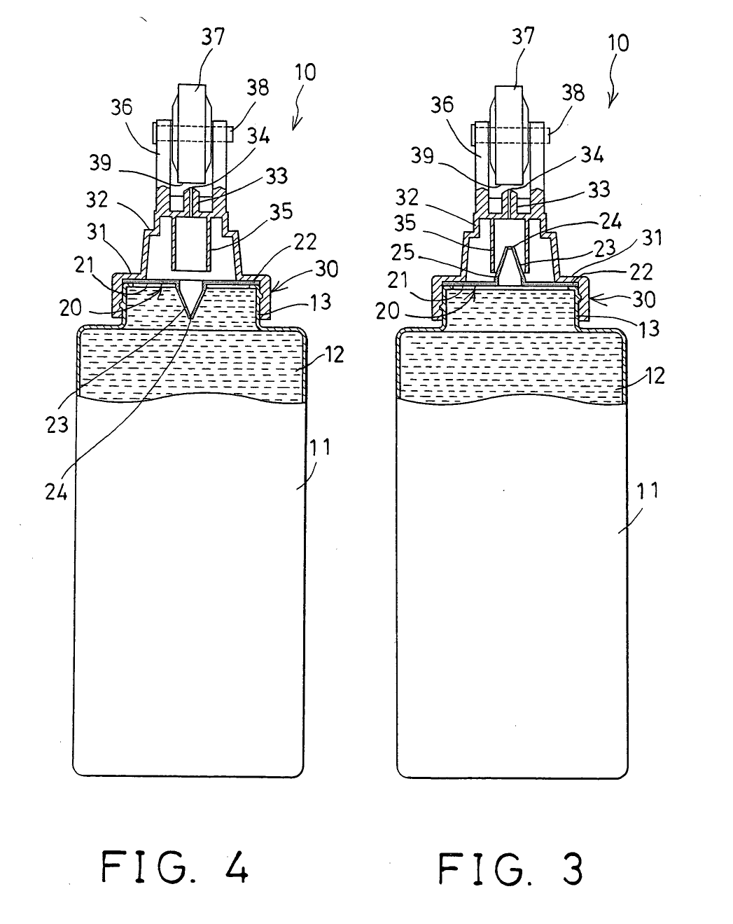

The control ferrule 30 includes a casing 32 provided thereon, or extended from the peripheral wall 31, and an outlet port 33 extended from the casing 32 and having an outlet orifice 34 formed therein, for discharging the sealer material (FIG. 5). It is preferable that the control ferrule 30 includes a tube 35 extended into the casing 32, for contacting or engaging with the nozzle 23 of the valve member 20 (FIGS. 3, 5), such as for engaging with the root portion 25 of the nozzle 23, and for confining the nozzle 23, and thus for allowing the discharge aperture 24 of the nozzle 23 of the valve member 20 to be easily opened.

The control ferrule 30 further includes one or more, such as two arms 36 extended therefrom, such as extended from the casing 32, for rotatably attaching a discharge wheel 37 thereto with a wheel axle 38. The discharge wheel 37 includes an outer peripheral surface 39 located close to or facing toward the outlet orifice 34 of the outlet port 33 (FIGS. 3-5), and arranged to receive the grout sealer material 90 flowing out from the outlet orifice 34 of the outlet port 33 (FIG. 5), and thus for allowing the grout sealer material 90 to be easily distributed or applied onto the ground with the discharge wheel 37.

In operation, as shown in FIG. 5, the grout sealer material 90 may be forced to open the discharge aperture 24 of the nozzle 23 of the valve member 20 by squeezing the container 11, and thus to flow out through the outlet orifice 34 of the outlet port 33, and then to apply onto the discharge wheel 37, and thus for allowing the grout sealer material 90 to be distributed or applied onto the ground with the discharge wheel 37.

It is to be noted that the squeezing force applied onto the container 11 will not applied onto the discharge wheel 37, and thus will not affect the moving of the discharge wheel 37 along or around the ground, such that the users may easily squeeze the container 11, to force the grout sealer material 90 to flow out through the discharge aperture 24 of the nozzle 23 and then to flow out through the outlet orifice 34 of the outlet port 33, and then to apply onto the discharge wheel 37, without affecting the movement of the discharge wheel 37.

As shown in FIG. 4, before use, or when the grout sealer applicator device 10 is made or manufactured by the manufacturers, the panel 21 and the nozzle 23 of the valve member 20 may be disposed or arranged up-side-down, to have the nozzle 23 engaged into the chamber 12 of the container 11. At this moment, when the grout sealer material 90 is forced against the nozzle 23, the discharge aperture 24 of the nozzle 23 may be forced to further be closed, and thus to prevent the grout sealer material 90 from flowing out through the nozzle 23.

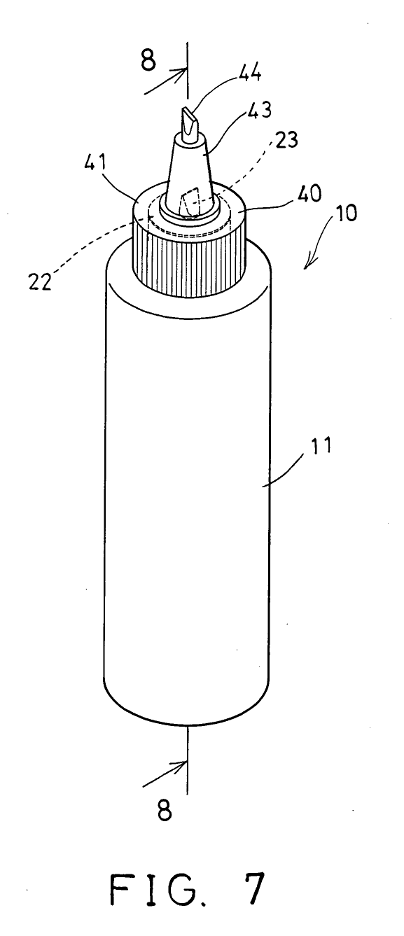

As shown in FIGS. 7-9, the grout sealer applicator device 10 may further include an additional cover 40 engageable or threadable with the mouth 13 of the container 11, for attaching or securing onto the mouth 13 of the container 11, and includes a peripheral wall 41 for engaging onto the outer peripheral flange 22 of the panel 21, and thus for stably compressing and retaining the panel 21 of the valve member 20 on top of the mouth 13 of the container 11, and thus for stably retaining and positioning the nozzle 23 of the valve member 20 relative to the container 11.

The cover 40 may be engaged or attached onto the mouth 13 of the container 11 when the control ferrule 30 is disengaged from the mouth 13 of the container 11, and further includes an outlet port 43 extended therefrom, and an outlet valve element 44 engaged into the outlet port 43, for selectively discharging the sealer material. As shown in FIG. 9, the panel 21 and the nozzle 23 of the valve member 20 may also be disposed or arranged up-side-down, to have the nozzle 23 engaged into the chamber 12 of the container 11, and to close the container 11, and thus to prevent the grout sealer material 90 from flowing out through the nozzle 23 and the container 11.

Accordingly, the grout sealer applicator device in accordance with the present invention includes a sealer receiving and storing structure for allowing the sealer to be easily applied onto ground or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A grout sealer applicator device comprising:
a container including a chamber formed therein to define a sealer reservoir and to receive grout sealer material therein, said container including a mouth provided on top thereof,
a control ferrule attached onto said mouth of said container, and including an outlet port having an outlet orifice formed therein, for discharging the sealer material,
a valve member attached onto said mouth of said container, and including a nozzle communicating with said chamber of said container, said nozzle including a discharge aperture formed therein, for selectively discharging the sealer material, and
a discharge wheel rotatably attached to said control ferrule, and including an outer peripheral surface facing toward said outlet orifice of said outlet port of said control ferrule, for receiving the grout sealer material from said outlet orifice of said outlet port, and thus for allowing the grout sealer material to be applied onto ground with said discharge wheel.

2. The grout sealer applicator device as claimed in claim 1, wherein said valve member includes a panel having an outer peripheral flange engaged onto said mouth of said container, and said control ferrule is engaged onto said outer peripheral flange of said panel, to stably compress and retain said panel of said valve member on top of said mouth of said container.

3. The grout sealer applicator device as claimed in claim 1, wherein said nozzle of said valve member is arrangeable and extendible into said chamber of said container, to selectively enclose said chamber of said container.

4. The grout sealer applicator device as claimed in claim 1, wherein said control ferrule includes a casing provided thereon, and having said outlet port extended from said casing, and includes a tube extended into said casing, for engaging with said nozzle of said valve member.

5. The grout sealer applicator device as claimed in claim 4, wherein said nozzle includes a root portion, said tube of said casing is engaged with said root portion of said nozzle, to allow said discharge aperture of said nozzle to be easily opened.

6. The grout sealer applicator device as claimed in claim 4, wherein said control ferrule includes at least one arm extended from said casing, said discharge wheel is rotatably attached to said at least one arm of said control ferrule with a wheel axle.

7. The grout sealer applicator device as claimed in claim 1 further comprising a cover selectively attachable onto said mouth of said container when said control ferrule is disengaged from said mouth of said container.

8. The grout sealer applicator device as claimed in claim 7, wherein said cover includes an outlet port extended therefrom, and an outlet valve element engaged into said outlet port of said cover, for selectively discharging the sealer material.
